(19) United States
(12) Patent Application Publication
(10) Pub. No.: US 2015/0302118 A1
(43) Pub. Date: Oct. 22, 2015

(54) METHOD FOR DETERMINING A GAS FLOW IN A GEOGRAPHICAL SPACE

(71) Applicant: COMMISSARIAT À L'ÉNERGIE ATOMIQUE ET AUX ÉNERGIES ALTERNATIVES, Paris (FR)

(72) Inventor: Frédéric Chevallier, Paris (FR)

(21) Appl. No.: 14/441,946

(22) PCT Filed: Nov. 12, 2013
(86) PCT No.: PCT/EP2013/073625

§ 371 Date: May 11, 2015

(30) Foreign Application Priority Data
Nov. 12, 2012 (FR) 12 60732

(51) Int. Cl. G06F 17/50; G06F 17/10

(52) U.S. Cl. CPC G06F 17/5009; G06F 17/10

(57) ABSTRACT

This method for determining a gas appearance or disappearance flow in a geographical space, from a priori flows, physical observations of the gas concentration values and the use of a numerical model expressing the gas behaviour and in particular its movements, and which comprises iterations of calculations and a convergence of successive determinations of flows towards a solution by minimizing a cost function, is characterized in that the model is implemented on succeeding time segments (5), however provided with overlay portions (6) enabling the correction of an inaccurate origin of the calculations of each one of the segments (5). Since the calculations concern increments of parameters and in particular concentration values, the segment results are collated with no difficulty. Application to the localization of gas sources, such as carbon dioxide.

The present invention relates to a method for determining, by localization or mapping, gas flows in a geographical space, these gas flows being quantities with which the considered gases appear or disappear in each region of this space.

These methods can be used to detect the place of origin of certain gases, such as methane or carbon dioxide, produced in particular by the combustions implied by the human activities. Negative flows, corresponding to a disappearance of these gases, also exist, for example thanks to the vegetation if it absorbs them.

Determination is enabled by the use of numerical models which express gas concentrations, in regions where the geographical space is discretised, as a function of positive or negative flows which are produced therein, gas transportations due in particular to the wind, and chemical reactions of combinations or dissociations which affect the gases and are equivalent to additional flows where gases are still produced or destroyed on site; these reactions are however nearly non-existent in the case of carbon dioxide, which is a highly stable gas. The results of the numerical models are correlated with observations, that is measurements of the gas concentration, in certain places of the geographical space (or even outside this space) and at certain times. The gas flows introduced in the model are considered as optimum if the gas concentrations deduced from the model correspond to observations in their confidence interval and if these flows correspond to a priori flows in their confidence interval. In other words, the flows are optimum if they are the best compromise between the concordance with the observed concentrations and the concordance with the a priori flows, given the accuracy of each piece of information. Mathematically speaking, the optimum flows and their uncertainty are expressed by the Bayes' theorem.

In practice, there are three types of methods for determining the optimum flows:
analytical methods, wherein the models are directly used, by using algebraic formulas;
methods by ensembles, which rely on statistical ensembles of simulations; and
variational methods, which rely on minimizing a so-called cost function, which expresses the sum of an overall difference between the observations and the concentration estimations and an overall difference between the determined flows and the a priori flows.

The article by W. Peters et al. “An ensemble data assimilation system to estimate CO2 surface fluxes from atmospheric trace gas observations”, Journal of Geophysical Research, vol. 110, D24304, Jan. 1, 2009, (2009-01-01), pp. 1-18, XP 055079774 describes a method by ensembles where the modelization calculations are carried out on ensembles of time segments, each calculation being performed on an ensemble devoid of the oldest time segment of the previous ensemble but provided with a new time segment located just after the previous ensemble. Calculations are thus performed on overlaying ensembles which are successively shifted towards the end of the study duration. Each one of the time segments is thus calculated as many times as there are ensembles to which it belongs, which enables a convergence towards a correct assessment of the concentrations. However time segments do not have any overlay portion. Calculations must be successively performed on each one of the time ensembles, and the calculation time is therefore more or less proportional to the number of time segment ensembles, which can be numerous in practice.

The method of the present invention is an improvement of the third category (variational methods). It will be described for a single gas, but can be applied to several gases.

Variational methods are those which best enable flow estimations with a high spatial and temporal resolution and from a large number of data to be obtained, the geographical space being able to cover the entire Earth and the duration being able to last decades, but in this case the calculation times become enormous.

The main purpose of the invention is to decrease this calculation time and to obtain estimation results within an acceptable period, by enabling flows to be estimated by parallel and simultaneous calculations independently performed on successive time segments, and enabling a synthesis of calculations to be made in a final step. Such a segmentation of the study duration is considered to be impossible in the variational methods.

According to the invention, modelizations of gas transportation are carried out separately on successive segments between which the study duration is divided, these segments having overlay portions, and the modelization results being expressed in each segment, in an incremental form of variations of the studied gas concentration.

Calculations can thus be performed by separated processors and simultaneously on each one of the segments. The calculation time becomes more or less proportional to the number of iterations to be performed, more reduced than the number of time segments to be considered. Assembling the segment results is easy. Correlation calculations between the concentration observations and estimations and the iterations are then carried out according to the known techniques. Unlike the modelization of gas transportation, these correlation calculations are performed at a higher level of the method, without segmenting the study period, once the segments are assembled according to the below explained modalities. The physical and statistical coherence of the model is fully respected from the beginning to the end of the study period for the proper assembly of segments.

According to certain characteristics which are optional but often advantageous, the overlay portions are all the longer that the geographical space is huge and the gas transportation in the space is slow; the modelization results of gas transportation are exploited in order to estimate the gas concentrations by excluding an overlay portion at the beginning of each one of the segments, for each one of the segments except for a first one of the segments, the results of which are fully exploited; and the method comprises adding a spatially uniform term to the results of each one of the segments except for the first one of the segments, so as to match the results of said segments with the results of previous segments obtained simultaneously with the overlay portions.

A purely illustrative embodiment of the different details and aspects of the invention will now be fully described by means of the following drawings:

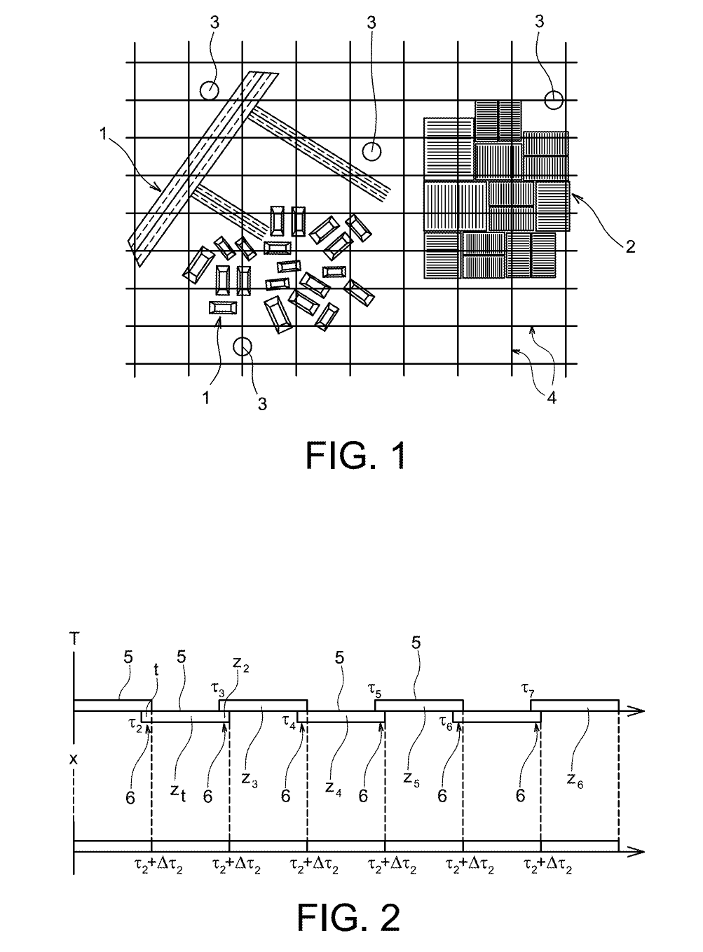

the modelization of FIG. 1 expresses the factors of the problem to be resolved and the modelization of a geographical space;

and FIG. 2 explains the elementary aspects of the invention.

By referring to FIG. 1, a geographical space can be seen where flows of a determined gas can appear and which in particular comprises places 1 where these flows preferably appear, possibly places 2 where they are absorbed, and observation stations 3, which measure the gas concentrations. The stations 3 can be placed in the same geometrical space where the flows appear or are absorbed, and also near this space. A gridding 4 covers all the considered geographical space and divides it into plots for the purposes of the modelization.

In the continuation of this description, the variables to be determined are called x (the gas flows expressed as a vector), the optimum value of these variables x is called x^{a} and the covariance of the error matrix of x is called A, the variables x being expressed in a Bayesian form of a probability distribution, an a priori estimation of the variables is called x^{b} and its covariance matrix is called B, the numerical model of the flow evolution is called H, its Jacobian matrix is H (the coefficients of which correspond to the local values of the partial derivates of the model H) and its error matrix is R. Parameters of the model comprise measurements or other estimations of meteorological phenomena, such as the wind velocity and direction, temperature, pressure, etc. in order to assess the considered gas transportation in the geographical space and at its boundaries. The optimum estimation theory indicates that x^{a} corresponds to the minimum of the cost function J(x), where

$$J ( x ) = \frac{1}{2} {( x - {x}^{b} )}^{T} {B}^{- 1} ( x - {x}^{b} ) + \frac{1}{2} {( H ( x ) - y )}^{T} {R}^{- 1} ( H ( x ) - y ) \qquad ( 1 )$$

The search for this minimum implies iterations where the unknown x is modified each time, and which implies calculations of gradient of the cost function J, that is

∇J(x)=B⁻¹(x−x^{b})+H^{T}R⁻¹(H(x)−y) (2)

Finally, matrix A can be calculated according to

A=(∇²J(x))⁻¹ (3)

The inventor has demonstrated (F. CHEVALLIER et al.: “Inferring CO₂ sources and sinks from satellite observations: Method and application to TOVS data”, in Journal of Geographical Research, vol. 110, D 24309, Dec. 29, 2005) the application of these principles.

The present method exploits a linearization of the numerical operator H. It is indeed possible to demonstrate that

δc(t)=Σ_{t′=T}^{t}H_{t′t}^{φ}·δφ(t′)+H_{t′t}^{C}·δc(T) (4)

where δc(t) is the vector which contains concentration increments at the time t, δφ(t′) the vector which contains the flow increments and the increments of lateral boundary conditions (appearances and disappearances of the gas in the geographical space, and inlets and outlets of the gas at the boundaries of the geographical space where the calculation is made); H_{t′t}^{φ} is the linear operator which connects the concentration increments at the considered time, to the flow increments and to the increments of the lateral boundary conditions; H_{t′t}^{C} is the linear operator which connects the concentration increments at the considered time, to the concentration increments at the origin. H_{t′t}^{φ} and H_{t′t}^{C} are blocks of the general matrix H.

The invention comprises the division of the calculation into successive segments 5, represented in FIG. 2, which is a diagram of the time axis. Each one of the segments 5 has an origin τ, such that inside each one of them, the previous expression becomes

δc(t)=Σ_{t′=τ}^{t}H_{t′t}^{φ}·δφ(t′)+H_{t′t}^{C}·δb(τ,t) (5)

where δb(τ, t) is a scalar representing the mean destiny, at the time t, of the concentration increment that existed at the time τ. It depends on the time t because of the possible chemical combination or destruction of the gas. If however the gas is chemically inactive, which is the case of CO₂, δb(τ, t) does not depend on t and therefore remains constant throughout the segment. The physical and statistical coherence of the overall method depends on a proper processing of this term H_{t′t}^{C}·δb(τ, t).

The numerical model H being known, it is easy to calculate the values δc(t) inside each one of the segments 5, the δφ(t′) being known, and then to assemble the segments in order to determine the full evolution of δc(t) throughout the study duration, to obtain the estimations of the gas concentrations c on all the regions of the model and at all times and to perform the previous calculations on the cost function. Assembling the segments then amounts to assessing the variations in concentration δc(t) throughout the study duration, and then to estimating the concentrations c(t) based on the sums of these variations. The numerical model is again applied on the segments by successive iterations by converging the flow estimations towards the values minimizing the cost function, or the concentration estimations towards the concentration measurements. Indeed, calculations of formula (5) can be performed independently of one another on each one of the segments 5. However, the segments 5 have overlay periods 6 of a duration Δτ, the reason of which being explained by the existence of the second term, that is the coefficient δb(τ, t).

Two cases may occur. In a geographical space without a lateral boundary condition of gas inlet or outlet, which is in particular the case of a model covering the entire Earth, the term δb(τ, t) of each segment 5 after the first is obtained from the preceding segment 5 by averaging the values of δc(τ). For example, for the second segment starting at the time τ2, the values of δc(τ) obtained in the first segment starting at the time τ2 are averaged for all the considered regions of the geographical space, in order to obtain δb(τ₂, τ₂) which is then exploited throughout the remaining second segment as a corrective term. δb(τ, t) can be constant overtime or corrected regarding chemical absorption as in the case of methane. The same will be done at all the following overlays 6. The overlays 6 of the segments 5 therefore provide a link between the calculations of δc(t) throughout the study duration. The choice of a constant value δb(τ, t) over the geographical space expresses the hypothesis that the movements of the gas from any point can bring it towards any other point of the model after a sufficient time, and that a stable distribution is plausible and likely to lead to statistically satisfying results.

For the models comprising lateral boundary conditions, that is interactions comprising movements of the gas between the considered geographical space and the neighbouring spaces, the situation is even simpler, since the term δb(τ, t) can be totally neglected. It can be indeed considered that the renewal of atmosphere in each one of the regions of the geographical space is complete after a sufficient time, such that the influence of origin (τ) has become non-existent. The calculations between the various segments 5 are then assumed to be totally independent, and their values are not adjusted by any corrective term; the overlays 6 nevertheless remain necessary, since the beginnings of segments 5 remain submitted to the origin conditions, which are used to start the calculations, but the results obtained at the beginning of segments 5 during these overlays 6 are not taken into consideration.

The duration of the overlay periods 6 is chosen considering that a too short overlay can lead to significant calculation errors and that a too long overlay results in unnecessary more significant calculations.

In a particular embodiment, the variational method of the present inventor, indicated in the abovementioned article, has been used. The model of transportation used was the general circulation model LBDZ known in the art. Flows were estimated on a global modelization grid (regular meshing of 3.75° by 2.5°), at a time resolution of eight days, separating the day and the night. The a priori flows comprised estimations of yearly anthropogenic emissions, oceanic climatological flows, emissions due to biomass combustion, and flows exchanged between biosphere and atmosphere. Observations were mole fractions of CO₂ in dry air, collected in vials onshore and offshore, and registered in the NOAA Earth System Research Laboratory archives, for the period between 1979 and 2010. The duration of the segments was fifteen months, from October of each year until December of the following year with three overlay months, except for the first segment, which lasted twelve months, throughout the first study year (1979).

Calculations could be performed in a few days thanks to the invention, whereas several months would have been needed without this paralleling of the calculations on the segments 5. A conventional method was however implemented, over a reduced duration from 1979 till 1992. Differences between its results and those of the invention were reduced (20% at most). A second calculation, performed according to the method of the invention, but with eighteen-month segments, among which six overlay months, gave results which differed very slightly from the preceding calculation, such that we can estimate that a three months overlay between time segments 5 was here sufficient.

In the case of a geographical space having for example the size of a town, the overlay will be at most a few days. The overlay will be shorter if the meteorological phenomena (in particular the gas transportation) are quick in the considered space. On the contrary, the overlay will be longer if the meteorological phenomena are slow.

These overlay values are valid even for several month-segments.

The method of the invention is in principle usable for any model used in the art. The known models can be distinguished from one another in particular by the meteorological and physical phenomena taken into account (wind, temperature, pressure, convection, exchanges with the outside and in particular the upper atmosphere), the discretization of the space (horizontally and vertically, the model being able to be applied to several successive layers above the ground surface), and the chosen numerical operator (Eulerian or Lagrangian for example). They try to describe the gas transportations, with an accuracy which in particular depends on the number of parameters they use, on the volume of available observations and hypotheses made to compensate for the absences of measured or known data. The cost function can be expressed in several ways; it is all the higher that the differences between the estimations of concentrations and the measurements (observations) of these same concentrations are also high.

What is claimed is:

1-6. (canceled)

7. A method for determining gas flows, appearing or disappearing in a geographical space, comprising:
a priori estimating the flows;
measuring (8) gas concentrations (c);
measuring meteorological phenomena, comprising wind directions and velocities in the geographical space, within a study duration between flow determining times and measuring times;
applying a numerical model (H) giving estimations of gas concentrations at the measuring times (y₁, y₂, . . . ) based on flow estimations and modelizations of gas transportation in the geographical space according to the measured meteorological phenomena; said applications being iterative in order to converge the flow estimations towards real flows;
characterized in that the modelizations of gas transportation are separately carried out on successive segments (5) between which the study duration is divided, the segments having overlay portions (6), and have results expressed as variations in gas concentration (δc(t)).

8. The method for determining gas flows according to claim 7, characterized in that the overlay portions are all the longer that the geographical space is huge and the gas transportation in space is slow.

9. The method for determining gas flows according to claim 7, characterized in that the modelization results of gas transportation are exploited in order to estimate gas concentrations excluding an overlay portion at the beginning of each one of the segments, for each one of the segments except for a first one of the segment, the results of which are fully exploited.

10. The method for determining gas flows according to claim 9, characterized in that it comprises adding a spatially uniform term (δb(t)) to the results of each one of the segments except the first one of the segments, so as to match the results of said segments with the results of the previous segments obtained simultaneously with the overlay portions (6).

11. The method for determining gas flows according to claim 7, characterized in that the variations in gas concentration are estimated by
δc(t)=Σ_{t′=τ}^{t}H_{t′t}^{φ}·δφ(t′)+H_{t′t}^{C}·δb(τ,t)
where t is the time, τ is an origin time of a segment, H_{t′t}^{φ} and H_{t′t}^{C} the linearized operators of the model (H) at a determined time and place, δφ increments of flows and boundary conditions, δc the variations in concentration, and δb is a scalar.

12. The method for determining gas flows according to claim 11, characterized in that, for a first one of the segments, the variations in gas concentration are estimated by
δc(t)=Σ_{t′=T}^{t}H_{t′t}^{φ}·δφ(t′)+H_{t′t}^{C}·δc(T)
where T is an origin of the study duration.
